(19) United States
(12) Patent Application Publication
(10) Pub. No.: US 2012/0111677 A1
(43) Pub. Date: May 10, 2012

(54) HEAT-INSULATING COMPONENT FOR BRAKE ASSEMBLY

(75) Inventor: Alvise Fracasso, Venezia (IT)

(73) Assignee: KEMATIS PROJECTS LIMITED, London (GB)

(21) Appl. No.: 13/289,236

(22) Filed: Nov. 4, 2011

(30) Foreign Application Priority Data
Nov. 4, 2010 (IT) MI2010A002050

(51) Int. Cl. B60T 1/06; B29C 45/00; B29C 59/00; E04B 1/78; F16D 51/00; F16L 59/00; B32B 3/26; B32B 27/04; B29C 43/00; F16D 55/22

(52) U.S. Cl. 188/325; 264/319; 264/328.1; 264/293; 188/71.6; 442/136; 442/147; 428/156; 428/220; 428/174; 252/62

(57) ABSTRACT

The present invention refers to a heat-insulating component for a break assembly, characterised in that said component is in the form of a single-layer resulting from the combination of a resin and a substrate.

### FIELD OF THE INVENTION

The present invention concerns heat-insulating components in brake assembly for auto vehicles, motor vehicles and similar. More in detail, the present invention concerns heat-insulating plates applied to a hydraulically or electro-hydraulically operated brake assembly, to which the description that follows makes explicit reference, but without any loss in generality.

### BACKGROUND OF THE INVENTION

As it is known, all the auto-vehicles motor vehicles and similar currently in circulation are equipped with hydraulically or electro-hydraulically operated brake assemblies, which are basically composed of a metal or carbon-ceramic disc of adequate thickness that is solidly fixed to the wheel of the vehicle and coaxial with the latter's axis of rotation so that it can turn around said axis integral with the same wheel; a rigid support structure solidly fixed to the vehicle's suspension such that it is positioned astride the metal or carbon-ceramic disc without coming into direct contact with the latter; a pair of brake pads in a material with a high coefficient of sliding friction, traditionally known as “pads”, which are located on the rigid support structure in symmetrical positions on opposite sides of disc so that each one faces a respective face of the disc close to the disc's external edge; and, lastly, a set of single-action hydraulic pistons that are placed between the rigid support structure and the two brake pads in order to push the two pads against the body of the disc so as to dissipate the vehicle's kinetic energy by friction, thus causing the vehicle to stop.

Since dissipation of the vehicle's kinetic energy by friction causes a rapid rise in the temperatures of the disc and the brake pads, and given that the temperatures reached by these components can exceed 900° C., in recent years the need has arisen to prevent the hydraulic pistons that push the pads against the disc from reaching temperatures that could cause the oil they contain to boil. This phenomenon would irreparably endanger correct operation of the brake assembly.

To avoid this risk, hydraulically operated brake assemblies have been presented during recent years that are equipped with two heat-insulating plates in composite materials, each of which is inserted between a pad of the brake assembly and the hydraulic piston(s) that push the same pad against the disc. More in detail, the two heat-insulating plates in composite materials are fixed on the rear faces of the two brake pads so that they are positioned between the same pads and the cylinder heads of the hydraulic pistons that push the pads against the disc, and each one of them is formed by one or more stacked layers of metal wires opportunely interwoven with glass fibres and/or carbon fibres and/or aramide fibres and embedded in an epoxy resin matrix.

Unfortunately, experimental tests carried out on the new brake assemblies have not given the results hoped for: the current heat-insulating plates in composite materials cannot, in fact, completely insulate the hydraulic pistons from the heat generated by friction of the pads on the surface of the disc, and are limited to reducing the rate at which the oil contained inside the hydraulic pistons heats up and reaches boiling point.

In other words, if used for prolonged periods with particularly heavy braking, even the brake assemblies equipped with heat-insulating plates in composite materials cease to work after a brief period of time, because the oil in the hydraulic pistons cannot cool down sufficiently between successive braking manoeuvres and reaches its boiling point.

Further solutions, which attempted to solve the above problem, are directed to the use of insulating plates having a multi-layered structure which comprises two external layers in composite material formed by carbon fibres opportunely interwoven together and embedded in a polymer resin bonding matrix, and at least one compact central layer of silicate and, more specifically, of potassium aluminosilicate. More in detail, the two external layers of the heat-insulating plate are both formed by a carbon fibre mesh or fabric, preferably, but not necessarily, of the “TWILL” or “PLANE” type, while the bonding matrix of both the external layers consists of a high-temperature phenol-acrylic bonding resin.

This kind of configuration shows however many drawbacks. The first problem is given by the fact that the multi-layered structure constituted by materials having different nature and composition does not react uniformly to physical stress and therefore a detachment and disaggregation of the layers may occur, thus affecting the life-time of the plates.

A second, more relevant problem is characterised by the safety and the behaviour of the vehicles: due to the above-cited problems, the consumption of the multi-layered plates tend to delay the braking response, i.e. a fading effect on the brakes pedal may occur, what causes a misleading feeling to the driver by the evaluation of the braking distance. This effect is always increasing, proportionally to the plates consumption.

Finally, a third aspect is also constituted by the costs correlated to the production of a multi-layered structure and the need of its continuous substitution.

### DISCLOSURE OF THE INVENTION

The object of the present invention is that of providing heat-insulating plates for hydraulically or electro-hydraulically operated brake assembly, that can become immune from boiling risks for the oil contained in the hydraulic pistons that push the pads against the disc and which can solve the above-mentioned problems connected to the multi-layered structure. Therefore, according to the present invention, a heat-insulating plate for motor vehicles and similar is defined in claim 1. Further advantages are defined in the dependent claims.

A conventional brake assembly comprises a metal or carbon-ceramic disc of adequate thickness, which is suitable for being solidly fixed to the wheel of the vehicle or, alternatively, to the hub that supports the wheel of the vehicle, so that it is placed coaxially to the wheel's axis of rotation and so that it can turn around said axis integral with the same wheel. The brake assembly is also equipped with a pair of brake pads made in a material with a high coefficient of sliding friction, traditionally known as “pads”, which are mounted in a movable manner on opposite sides of the disc in symmetrical positions with respect to each other, and a set of single-action hydraulic pistons that, when operated, are able to push the two pads against the body of the disc to make the two pads rub against its surface. According to the present invention, the brake assembly also comprises two heat-insulating components in the form of plates having a planar or any other possible shape depending on the specific needs, each of which is inserted between a respective pad and the hydraulic piston(s) that push said pad against the disc.

The single-layered structure constituting the object of the present invention results from the combination of a resin and a substrate, wherein the resin is:
(a) A thermoset resin chosen among the group constituted by phenolic resins, silicon resins or the combination of the two,
(b) The combination of one or both the resins of point (a) above with one or more resins chosen in the group comprising epoxy resins, polyester resins, melamine resins, vinylester resins or Bakelite,
(c) A thermoplastic resin chosen in the group constituted by plyimide, polyetheretherketone, polyetherketoneketone, polyphenylene sulphide, polyetherimide or a combination thereof
   whilst the substrate is constituted by one or by the combination of the following alternatives:
mica paper, muscovite mica paper, phlogopite mica paper or similar;
fibers of glass, cotton or basalt in mat, cloth, compound or chop form.

The monolayer is obtained by injection or, in the case of thermoset resins according to items (a) and (b), by moulding techniques like SMC (sheet moulding compound) or similar, or by injection moulding techniques like BMC (bulk moulding compound) or similar, or by compression moulding with subsequent cut, so to obtain laminates of different form and structure which can be adapted to any condition and need.

According to one preferred embodiment, the heat-insulating monolayer is obtained by heat or cold compression moulding of thermoset or thermoplastic resins, with continuous pressure laminating technique, embossing of laminates or by pressure tank technique.

The thickness of the plate according to the present invention is comprised between 0.4 and 8 mm, the density is comprised between 1.4 and 2.4 g/cm3, preferably between 2 and 2.4 g/cm3, more preferably is 2.2 g/cm3, while the thermal conductivity is comprised between 0.1 and 0.5 W/mK, preferably between 0.15 and 0.25 W/mK, more preferably is 0.2 W/mK.

The particular structure of the heat-insulating plate offers an insulation which is definitely higher than in any other previous solution and therefore the oil life-time is greatly increased.

In other words, the heat-insulating plate is able to constantly keep the oil present inside the hydraulic pistons well below the boiling point, even when the temperature of the disc and the pads is higher than 1000° C.

The advantages offered by the above-described heat-insulating plates are evident: the brake assemblies made in this manner are able to support particularly severe conditions of use for extremely long periods without showing the slightest loss in efficiency. In particular, the plate according to the present invention has a consumption resistance which is much higher than the one shown by the solutions proposed in the state of the art: after 100.000 Km of tests performed on different vehicles and in different weather and environmental conditions and from the results of computer simulations, the plate remains 100% intact. This corresponds also to a constant and uniform breaking behaviour, thus providing a high level of security and reliability to the driver.

According to an embodiment variant, the brake assembly can be equipped with a drum in substitution of the disc. Similarly to the disc, the drum is rigidly fixed to the hub that supports the wheel of the vehicle so that it is able to rotate integrally with the wheel around the wheel's axis of rotation.

In this case, the two brake pads both have a curved shape and are rigidly fixed so that they can be brought into contact with the internal cylindrical surface of the drum, while the heat-insulating plates, which have a curved shape as well, are inserted between the pads and two curved brake shoes on which the hydraulic pistons operate.

1. A heat-insulating component for a brake assembly in vehicles, the heat-insulating component having a mono-layered structure comprising a combination of a resin and a substrate, wherein the resin includes one or more of the following:
a. a thermoset resin selected from the group consisting of phenolic resins, silicon resins, and a combination of the two,
b. a combination of (i) thermoset resin selected from the group consisting of phenolic resins, silicon resins, and the combination of the two, plus (ii) one or more resins selected from the group consisting of epoxy resins, polyester resins, melamine resins, vinylester resins and Bakelite, and
c. a thermoplastic resin selected from the group consisting of one or more of polyimide, polyetheretherketone, polyetherketoneketone, polyphenylene sulphide, polyetherimide, and a combination thereof,
and wherein the substrate comprises one or more of the following:
(i) mica paper, muscovite mica paper, phlogopite mica paper; and
(ii) fibers of glass, cotton or basalt in mat, cloth, compound or chop form.

2. The heat-insulating component according to claim 1, characterised in that said component is formed by compression moulding.

3. The heat-insulating component according to claim 2, wherein the compression moulding is SMC.

4. The heat-insulating component according to claim 1, wherein the component comprises a thermoplastic resin or a thermoset resin and the component is formed by injection moulding.

5. The heat-insulating component according to claim 4, wherein the injection moulding is BMC.

6. The heat-insulating component according to claim 1, characterized in that the component is formed by the embossing of laminates with subsequent cutting.

7. The heat-insulating component according to claim 1, characterised in that said component is formed by heat or cold compression moulding of thermoset or thermoplastic resins, utilizing one of the following techniques: continuous pressure laminating, embossing of laminates, or pressure tank forming.

8. The heat-insulating component according to claim 1, characterised in that said component has a thickness of between 0.4 and 8 mm.

9. The heat-insulating component according to claim 1, characterised in that said component has the form of a flat or curved plate.

10. The heat-insulating component according to claim 1, characterised in that its density is between 1.4 and 2.4 g/cm³.

11. The heat-insulating component according to claim 1, characterised in that its density is between 2 and 2.4 g/cm³.

12. The heat-insulating component according to claim 1, characterised in that its density is 2.2 g/cm³.

13. The heat-insulating component according to claim 1, characterised in that its thermal conductivity is between 0.1 and 0.5 W/mK.

14. The heat-insulating component of claim 1, characterised in that its thermal conductivity is between 0.15 and 0.25 W/mK.

15. The heat-insulating component of claim 1, characterised in that its thermal conductivity is 0.2 W/mK.

16. A brake assembly for use in a motor vehicle, the brake assembly including the heat-insulating component of claim 1, wherein said heat-insulating component is inserted between a brake pad and one or more hydraulic pistons that push said brake pad against a disc coupled to a vehicle wheel, wherein said disc rotates together with the wheel.

17. The brake assembly according to claim 16, wherein said brake assembly is configured as a drum which is rigidly fixed to a hub that supports the vehicle wheel, so that the brake assembly is able to rotate integrally with the vehicle wheel around the vehicle wheel's axis of rotation, the brake assembly comprising (a) two brake pads, both of which have a curved shape and that are rigidly fixed, and (b) two heat-insulating components, wherein one is for use in conjunction with each brake pad, each of the heat-insulating components having a curved shape; wherein each of the brake pads can be brought into contact with an internal cylindrical surface of the drum while one of the heat-insulating components is inserted between each of the brake pads and two curved brake shoes on which the one or more hydraulic pistons operate.
